(19) United States
(12) Patent Application Publication
(10) Pub. No.: US 2018/0361603 A1
(43) Pub. Date: Dec. 20, 2018

(54) TRANSFERRABLE VIBRATING SYSTEM FOR USE WITH HAND HELD RAZORS

(71) Applicant: William Charles Griffin, St. John's (CA)

(72) Inventor: William Charles Griffin, St. John's (CA)

(21) Appl. No.: 15/990,744

(22) Filed: May 28, 2018

Related U.S. Application Data
(60) Provisional application No. 62/521,500, filed on Jun. 18, 2017.

(51) Int. Cl. B26B 21/38; B26B 21/52

(52) U.S. Cl. CPC B26B 21/38; B26B 21/06; B26B 21/526

(57) ABSTRACT

A transferrable vibrating system for use with hand held razors which includes a housing in which is disposed a battery, a switch and a motor driving a vibrating element. The system is easily removed from one hand held razor and attached to another and would be preferably waterproof. One preferred embodiment of the present invention would be preferably waterproof and might include a housing that is completely sealed, preferably buoyant and capable of floating while attached to a razor. Another embodiment of this invention would be preferably waterproof and provided with a rechargeable battery that might be recharged via wireless, inductive charging. Another embodiment would be preferably waterproof and provided with a cap to allow access to a replaceable battery. Another embodiment would be preferably waterproof and provided with a port allowing the direct connection of an external DC power source to a rechargeable battery contained in the housing.

### RELATED APPLICATIONS

This application claims priority to U.S. Provisional Patent Application No. 62/521,500 titled “Transferrable Vibrating System for Use With Hand Held Razors” filed on Jun. 18, 2017, to which Applicant claims the benefit of the earlier filing and which is incorporated herein by reference in its entirety.

### FIELD OF THE INVENTION

The present invention relates generally to shaving and more particularly to systems that use vibration to assist with shaving and still more particularly, to systems that are easily removed from one hand held razor and attached to another.

### BACKGROUND OF THE INVENTION

Vibrating hand held razor shaving systems have been known for some time and there are multiple examples of prior art systems. An example of a prior art system might be seen in U.S. Pat. No. 5,299,354. These systems generally utilize a power source and some form of vibrating device contained within and integral to the razor system. Typically, these systems only accept certain, compatible blade types for each particular, vibrating system and do not accommodate the use and interchangeability of conventional hand held razors. Additionally, many of these systems not do not float which, when used in a bathtub for example, might pose a safety concern if a user accidentally sat on the blade section of a razor.

Other prior art might be seen in U.S. Pat. No. 6,481,104 B1. In this patent, one embodiment uses a vibrating, hand-holdable housing sized to retain the shaft or handle portion of a manual shaver. This type of system has attempted to solve the problem of accommodating multiple types of conventional hand held razors noted earlier in this section. This type of system has not sufficiently addressed the needs of the industry. One problem is that there is a potential for water ingress at the interface between a conventional razor handle and the system housing. This interface area would be complex, relatively costly and possibly require multiple different interface sealing configurations to ensure the adequate water resistance needed to accommodate the numerous sizes, profiles, cross-sections, material types and shapes associated with common razor handles. One common example of a hand held razor with a cross-section that would be difficult to adequately seal using the system described in prior art might be seen in FIG. 14. In particular, notice a deep groove running the entire length of the handle section of the hand held razor shown in FIG. 14. This type of groove and other similar types of groves and irregular cross-sections are commonly found on numerous, common hand held razors and would make water sealing difficult without introducing complexity and cost. Water ingress might promote bacterial growth and would have to be cleaned by a user, assuming the wetted areas were accessible. Additionally, incomplete sealing at the interface noted previously, might permit dust, sand or other fine debris to enter the system. Another problem with this type of system includes its awkwardness due to size and, as noted in U.S. Pat. No. 6,481,104 B1 for example, this system may be uncomfortably large for users having small hands. The size and shape of this system might make it unusable for some users and possibly bulky.

Still other prior art might be seen in U.S. Pat. No. 2,387,765A. In this prior art a floating razor is described along with multiple examples where a floating razor would be advantageous while a user shaved outdoors near or over a body of water. One problem with this prior art is that the user must use the handle that is supplied with the invention and would not be able to interchange other hand held razors that the user may want to use.

It would therefore be desirable for a transferrable vibrating system for shaving to be easily attachable to multiple conventional hand held razor and straight razor systems, preferably be waterproof, preferably be buoyant enough to float while attached to a hand held razor, preferably be operable while submerged in water, preferably be dust proof, not awkward to handle, not complex and relatively low cost. Another embodiment would preferably be capable of wireless charging. Yet another embodiment would preferably contain rechargeable batteries and preferably be charged by connecting an external power source to the batteries through a watertight port on the housing. Yet another embodiment might contain a removable cap for access to replaceable batteries.

### SUMMARY OF THE INVENTION

A preferred embodiment of a transferrable vibrating system for a razor is comprised of a housing, composed of silicone or other elastomeric material. A portion of the housing has an aperture to allow attachment to a conventional hand held razor or straight razor by stretching the aperture sliding it over the razor and subsequently allowing it to contract onto the razor forming a tight fit. The housing is waterproof and comprised of one continuous unit. The housing contains a battery, a DC motor with an eccentric weight attached to a shaft, connecting wires, a switch operable through the housing and preferably a small internal frame composed of plastic or other rigid material. The entire system is buoyant and contains enough air to float in water while attached to many common conventional hand held or straight razors. The transferrable vibrating system for a razor is completely sealed and is operable while submerged in water or operated in dusty environments.

A second embodiment of a transferrable vibrating system for a razor is similar to the preferred embodiment except that it is wirelessly charged, preferably using an inductive receiver. Inductive, wireless charging is well known and can be seen in prior art. Briefly, the receiver unit is comprised of a receiver coil, a rectifier to convert the AC to DC current, a capacitor or resistor and a zener diode, re-chargeable battery(s), a regulator or charge management chip(s) or other programmable chip(s). These chip(s) might include information such as voltage, degree of charging, temperature and other parameters designed to safely operate the system. Additionally, the management chip(s) might regulate the power drawn from the circuit to ensure over-charging does not occur or additionally may be capable of communicating information with the power transmitting system to ensure optimal charging. The receiver might be used with a purpose built, inductive charging base or a generic charging base transmitter suitable for inductive charging with the receiver unit. The charger base is not part of this patent. Additionally, the housing of this embodiment has at least one flat surface to allow the system to sit on the transmitter coil without rolling off or moving. Additionally, the shape of the housing will assist with keeping the receiver coil in close proximity to the transmitter coil, a key factor in effective, inductive charging.

A third embodiment of a transferrable vibrating system for a razor is similar to the preferred embodiment except that it contains rechargeable batteries and is preferably charged by connection to an external DC power source via a watertight connector in the housing. The connector would be capable of accepting a standard sized DC charger connector. When the battery(s) power has drained, a user simply plugs in the DC charger connector into the connector on the present invention.

A fourth embodiment of a transferrable vibrating system for a razor is provided with a housing made of hard plastic or some other semi-resilient material and has a threaded cap and sealing o-ring as part of the housing. The housing is retained by and partially surrounded by a tight fitting, silicone or other elastomer sleeve that is sized to tightly fit around and hold the housing once pressed into place at the point of manufacture. A portion of the one-piece sleeve is designed with an integral aperture to allow attachment to a conventional hand held razor or straight razor by stretching and subsequently contracting the aperture onto the razor forming a tight fit. Removing the cap would allow access by the user to replace the battery(s). All other components of this embodiment are similar to the preferred embodiment.

### BRIEF DESCRIPTION OF THE DRAWINGS

FIG. 1 is a perspective view of the preferred embodiment of the present invention shown attached to a conventional hand held razor;

FIG. 2 is a perspective, cut away view of the preferred embodiment of the present invention showing internal components;

FIG. 3 is a front view of the preferred embodiment of the present invention;

FIG. 4 is a perspective view of the preferred embodiment of the present invention;

FIG. 5 is a perspective view of the second embodiment of the present invention shown attached to a conventional hand held razor;

FIG. 6 is a perspective view of the second embodiment of the present invention;

FIG. 7 is a perspective, cut away view of the second embodiment of the present invention showing internal components;

FIG. 8 is a perspective view of the third embodiment of the present invention;

FIG. 9 is a perspective view of the fourth embodiment of the present invention shown attached to a conventional hand held razor;

FIG. 10 is a perspective view of the fourth embodiment of the present invention showing only the plastic housing and associated cap;

FIG. 11 is a side view of the cap and o-ring of the fourth embodiment of the present invention;

FIG. 12 is a perspective, assembled view of the housing fitted inside the elastomer sleeve with the cap shown in the removed position;

FIG. 13 is a perspective view of the fourth embodiment of the present invention showing only the elastomer sleeve;

FIG. 14 is a perspective view of an example of a common hand held razor, showing a deep groove in the handle area.

### DETAILED DESCRIPTION OF THE EMBODIMENTS

In the following description, references are made to drawings, which form a part of the description and by way of illustration, specific embodiments. Although these embodiments are described in sufficient detail to enable one skilled in the art to construct the described embodiments, these examples are not limiting and other embodiments may be used that result in similar functional outcomes.

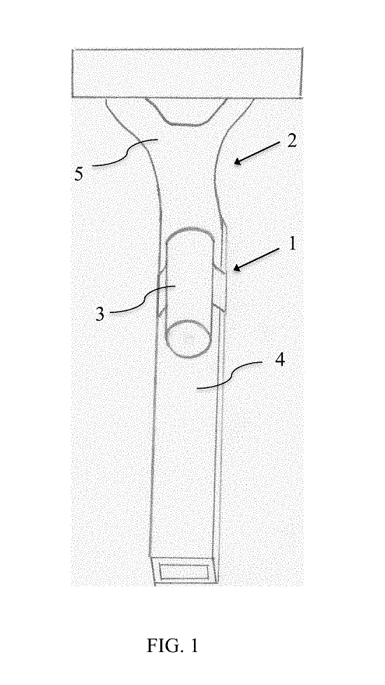

Referring now to the invention in more detail, in FIG. 1 there is shown a preferred embodiment of the transferrable vibrating system for use with a razor 1 attached to a conventional hand held razor 2. System 1 includes a housing 3, made of silicone or other elastomeric material and preferably a simple internal frame composed of plastic or other rigid material. The internal frame is used to mount the individual components inside the housing 3 and to resist relative movement of the components. The internal frame is not shown in the figures to avoid overcomplicating the drawings. The shape of the housing 3 and materials used are representative of one possible embodiment and those skilled in the art will appreciate that multiple similar shape profiles and multiple materials might be contemplated. The system 1 is shown in its operable position on the surface of the handle 4 of a conventional hand held razor 2. Alternately, system 1 might be attached at other locations on the surface of a conventional hand held razor 2 such as near the shaving head 5 or on the blade section. For simplicity FIG. 1 only shows attachment to a conventional hand held razor 2 but might also be easily attached to a straight razor or other similar shaving systems.

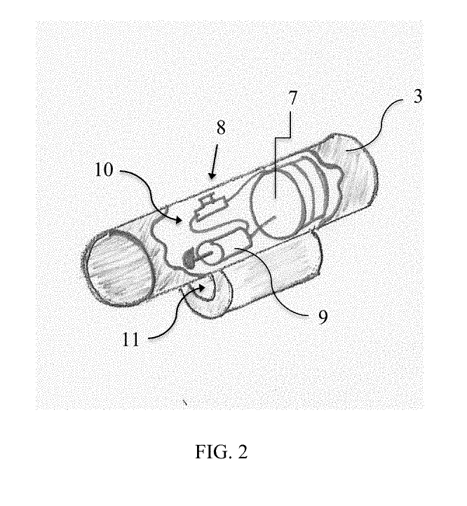

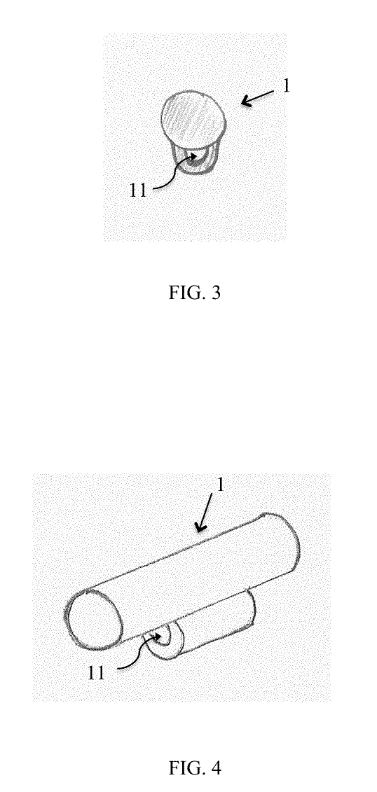

In further detail, and still referring to the preferred embodiment of the invention, FIG. 2 shows a cut away view of the transferrable vibrating system for use with a razor 1. Secured within the housing 3 is a battery(s) 7, a switch 8, a DC motor/output shaft/off-center weight 9 and connecting wiring 10. Also seen in this figure is an aperture 11, which runs lengthwise entirely through the lower section of housing 3. This aperture 11 can also be seen in FIG. 3 and FIG. 4 and is sized to slide onto the handle of common hand held razors when a user applies minimal force to elastically deform the aperture section 11 of the housing 3 as it stretches over the razor 2. Once positioned by the user, the vibrating attachment for the razor 1 will be firmly held by friction as the elastic properties of the aperture 11 causes it to contract around the razor 2. The switch 8 is a push button type and will be located sufficiently close to an exterior wall of the housing 3 so that it might be activated through the elastic housing 3. Once activated by pressing on it, the switch 8 will stay in the ON position until pressed again. The battery(s) 7 may be a few volts, approximately 1.5V, and when using multiple batteries 7, would be connected in parallel to increase amp hours. The small DC motor 9 has an encapsulated or enclosed off-centered weight connected to its output shaft. When energized, the motor shaft would typically rotate at a few thousand revolutions per minute, for example, up to 10,000 RPM when a few volts are applied to the motor winding. The rotation of the motor shaft will cause the weight to mechanically vibrate in system 1 and subsequently will vibrate the razor 2 and its connected blade(s). The intensity of the vibrations would be such that it will gently massage the skin being shaved but not too intense as to cause the user discomfort while operating it. The partially shown, interconnecting wiring 10, connects all components so that when the switch 8 is in the ON position, power from the battery(s) 7 will energize the winding of the motor 9 and when in the OFF position, will disconnect the battery(s) 7 from the motor 9 by opening the circuit.

In still further detail and describing the preferred embodiment, the attachment and operation of the invention shown in FIG. 1, FIG. 2, FIG. 3 and FIG. 4 starts with the user sliding and simultaneously stretching the elastomer housing aperture 11 over the handle section 4. The user will then slide the vibrating system 1 to their desired location along the handle 4 or up to the top of the razor section 5 using minimal effort. Once in place the vibrating attachment for a razor 1 will be firmly held by friction as the elastic properties of the housing 3 causes it to contract around the razor 2. To operate the vibration aspect of the invention, the user simply depresses the exterior of the elastic housing 3 at the point near where the switch 8 is located inside the housing thus activating switch 8. A marking on the exterior of the housing 3 will indicate the location of the switch 8 so that the user will know where to depress the housing to operate switch 8. Once activated, switch 8 will close the circuit between the battery(s) 7 and the motor windings therefore energizing the motor 9 and starting the motor shaft rotating. The rotating shaft will cause the system 1 to vibrate as the attached off-centered weight rotates. The user will then use the razor 2 as they would normally. Once shaving is complete, the user simply depresses the housing 3 at a point on near where switch 8 is located and the switch is turned to the OFF position, thus opening the circuit between the battery(s) 7 and the motor winding. If the user chooses to change razors by choice or when a blade(s) has become dull, the user simply removes the invention from the razor 2 and attaches it to another razor. When the battery(s) 7 has been drained of power, the user simply removes it from the razor 2 and disposes of it.

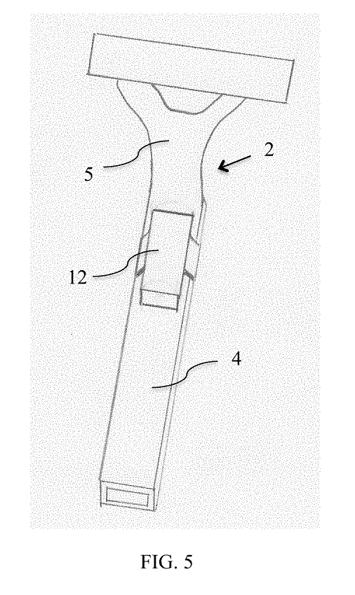

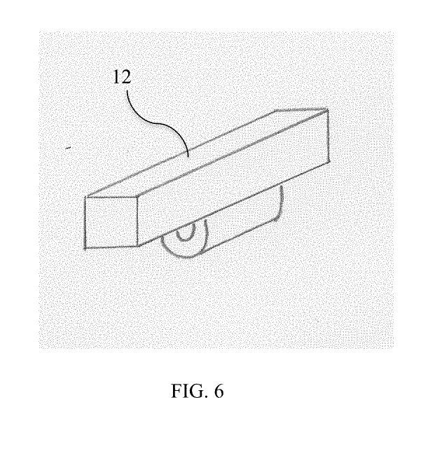

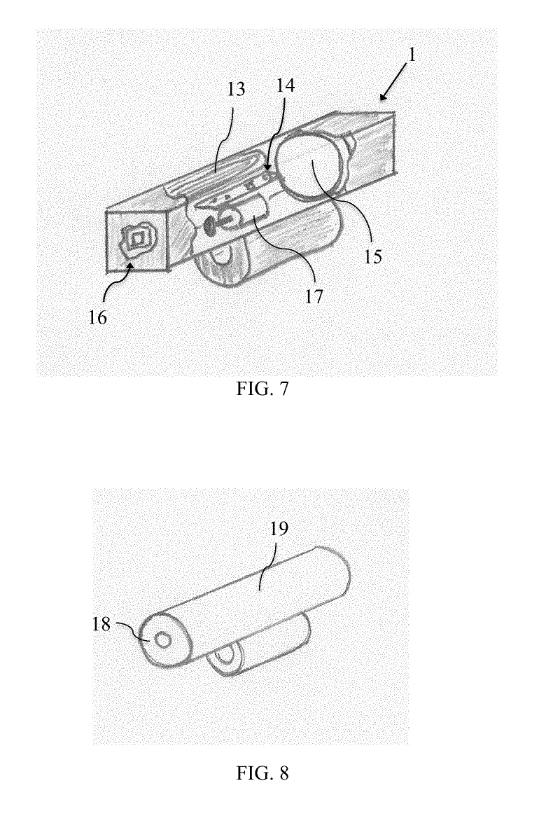

A second embodiment of the present invention is attached to a razor 2 and operated by a user in the same way as the preferred embodiment. FIG. 5 shows a housing 12 attached in a similar way to the razor 2 as the preferred embodiment. The housing 12 is constructed of the same elastomeric material as the preferred embodiment and contains a small plastic or other rigid frame for mounting components internally, similar to the preferred embodiment. Different from the preferred embodiment and seen in FIG. 5 and FIG. 6, this embodiment will have at least one flat side on the housing 12. Additionally, this embodiment will be capable of wireless, inductive charging using a receiver unit. Inductive wireless charging is detailed in numerous prior art examples and the preferable components required for this embodiment's functionality are briefly described herein. Shown in FIG. 7, this embodiment will have a receiver coil 13, and preferably located on a circuit board 14, a rectifier to convert the AC to DC current, a capacitor or, resistor and a zener diode. Also mounted on the circuit board, a regulator or a charge management chip(s) or other programmable chip(s). These chip(s) might include information such as voltage, degree of charging, temperature and other parameters designed to safely operate the system. Additionally, the management chip(s) might regulate the power drawn from the circuit to ensure over-charging does not occur or additionally may be capable of communicating information with the power transmitting system to ensure optimal charging parameters are maintained. This embodiment will contain re-chargeable battery(s) 15 such as Lithium Ion type. The receiver unit might be used with a purpose built, inductive, power transmitter charging base or a generic charging base suitable for inductive charging with this embodiment's receiver unit. A transmitter base is not part of this invention and not shown but can be seen in numerous examples of prior art. Similar to the preferred embodiment, this embodiment will have a switch 16, a DC motor/output shaft/off-center weight 17 and connecting wiring that is not shown in the Figures. The user might recharge this embodiment by laying the invention on an inductive transmitter charging station that is compatible with the present invention.

A third embodiment of the present invention is shown in FIG. 8 and is similar to the preferred embodiment except that it contains rechargeable batteries and is charged by direct connection to an external, DC power source preferably via a watertight, generic connector 18 mounted to an internal plastic frame which is slightly protruding from the elastomeric housing 19. The connector would be supplied with an integral, small, mechanical, compression fitting that, to when tightened, will firmly clamp the silicone housing inside and outside forming a water tight seal.

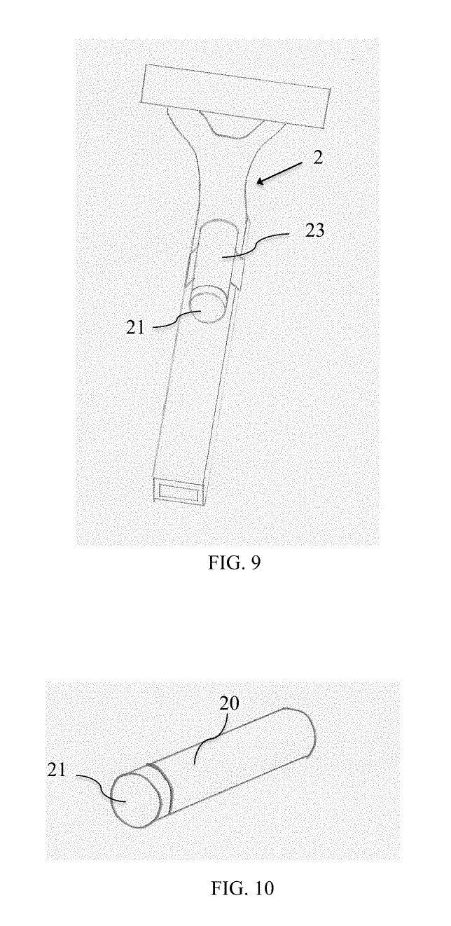

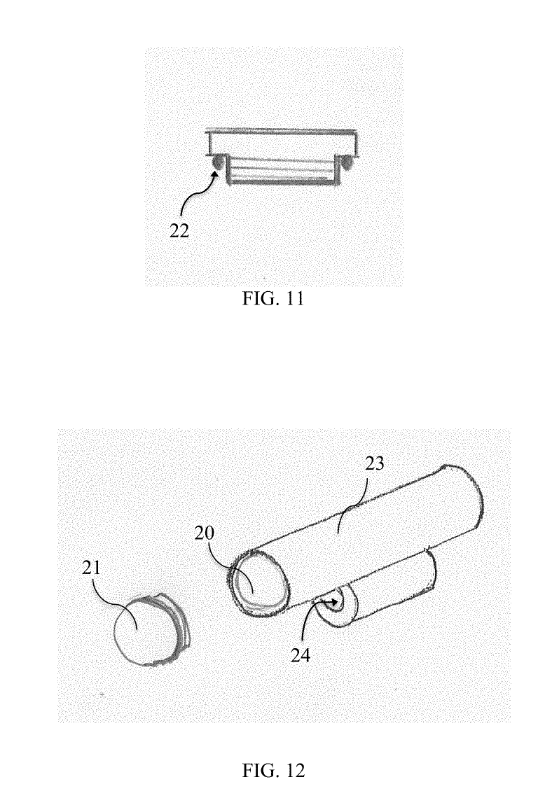

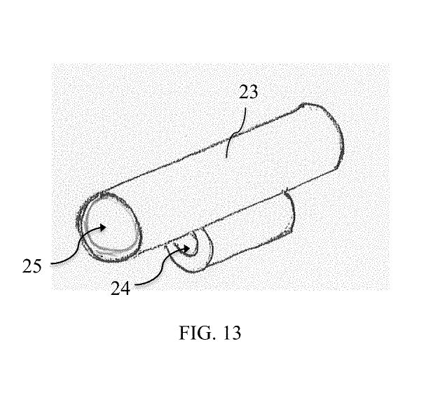

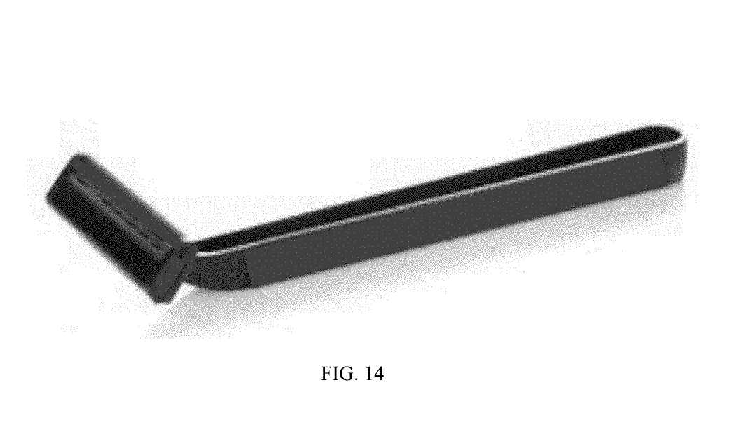

A fourth embodiment of the vibrating system for a razor is shown in FIG. 9, FIG. 10, FIG. 11, FIG. 12 and FIG. 13 and contains all of the internal components described in the preferred embodiment. This embodiment has a housing 20 that is different from the housing 3 of the preferred embodiment. This embodiment has a housing 20 made of hard plastic or some other semi-resilient material and includes an internally threaded section for accepting a cap 21. The cap 21 has an externally threaded section, suitable for engaging the threaded section of the housing 20. The cap 21 external threads will engage approximately 4 threads on the housing 20. The cap 21 would be composed of the same material as the housing 20 and preferably will have a sealing element such as a silicone or other elastomer type o-ring 22 located as shown in FIG. 11. The housing 20 is retained by and partially surrounded by a tight fitting silicone or other elastomer, sleeve 23 that surrounds the housing 20 but not the cap 21 area. The sleeve interior space 25 is sized to snugly accept the housing 20 when it is firmly pressed and subsequently deforms the sleeve 23, thus forming a tight friction hold. The housing 20 will preferably be pressed into the sleeve 23 at the time of manufacture and not meant to be removable by a user. A portion of the one-piece elastomer sleeve 23 is designed with an integral aperture 24 to allow attachment to a conventional hand held razor 2 or straight razor by stretching and subsequently contracting the aperture 24 onto the razor forming a tight fit. Removing the cap 21 from the housing 20 by turning the cap 21 and disengaging the threads would allow access to replace the battery(s), which are located inside the housing 20 near the cap 21.

The embodiments of the current invention described are provided for illustrative purposes only and should not be used to limit the scope of the present invention. Any modifications and variations in relation to the spirit of the present invention and capable of substantially similar outcomes shall be considered within the scope of this invention.

What is claimed is:

1. A transferrable vibrating system for use with hand held razors, comprising:
a housing, characterized in that, it is configured to easily attach to and detach from a hand held razor;
a DC motor contained in the housing;
a battery contained in the housing for powering the DC motor;
a vibration device contained in the housing and configured to be driven by the DC motor once said DC motor is connected to the battery;
a switch contained in the housing, operable from outside the housing, and configured to electrically connect and disconnect the battery from the DC motor;
a void in the housing, characterized in that, it is approximately sized to contain the battery, the motor, the vibration device and the switch.

2. The system of claim 1, wherein the housing is comprised of a continuous, single piece, characterized in that, it is configured to easily attach to and detach from a hand held razor.

3. The system of claim 1, wherein the housing is comprised of a continuous, single piece of elastomeric material having an integral aperture that is approximately sized to fit on a handle of a hand held razor when said aperture is elastically deformed.

4. The system of claim 3, wherein the housing is composed of a single, continuous piece of silicone.

5. The system of claim 1, wherein the vibration device is comprised of an off-centered weight, connected to a shaft that is connected to the DC motor.

6. The system of claim 1, wherein the vibration device and DC motor are comprised of a coin type vibration motor.

7. The system of claim 1, wherein the housing and its contents, are characterized in that, they are sufficiently buoyant to float in water while attached to a hand held razor.

8. The system of claim 1, wherein the housing is waterproof.

9. A transferrable vibrating system for use with hand held razors, comprising:
a housing, characterized in that, it is configured to easily attach to and detach from a hand held razor;
a DC motor contained in the housing;
a rechargeable battery contained in the housing for powering the DC motor;
a vibration device contained in the housing and configured to be driven by the DC motor when said DC motor is connected to the battery;
a switch contained in the housing, operable from outside the housing, and configured to electrically connect and disconnect the battery from the DC motor;
an inductive receiver piece and associated safety and operational equipment, characterized in that, it recharges the battery when placed in close proximity to an inductive transmitter;
a void in the housing, characterized in that, it is approximately sized to contain the battery, the motor, the vibration device, the inductive receiver and the switch.

10. The system of claim 9, wherein the housing is comprised of a continuous, single piece, characterized in that, it is configured to easily attach to and detach from a hand held razor.

11. The system of claim 9, wherein the housing is comprised of a continuous, single piece of elastomeric material having an integral aperture that is approximately sized to fit on a handle of a hand held razor when said aperture is elastically deformed.

12. The system of claim 11, wherein the housing is composed of a single piece of silicone.

13. A transferrable vibrating system for use with hand held razors, comprising:
a cap, characterized in that, it is composed of semi-resilient material, contains an externally threaded end section that is fitted with a compressible o-ring;
a housing, characterized in that, it is composed of semi-resilient material containing an internally threaded section at one end suitable for connection to said cap and, once connected to the cap by screwing the two sections together, will form a waterproof join;
said housing, characterized in that, it is configured to easily attach to and detach from a hand held razor;
a DC motor contained in the housing;
a battery contained in the housing for powering the DC motor, the battery is configured in the housing to be easily removed and replaced by unscrewing the treaded cap from the housing;
a vibration device contained in the housing and configured to be driven by the DC motor when said DC motor is connected to the battery;
a switch contained in the housing, operable from outside the housing, and configured to electrically connect and disconnect the battery from the DC motor;
a void in the housing, characterized in that, it is approximately sized to contain the battery, the motor, the vibration device and the switch.

14. The system of claim 13, wherein the housing is snugly retained by, and partially surrounded by, a tight fitting elastomer sleeve;
said elastomer sleeve is comprised of a continuous, single piece of elastomeric material containing an integral aperture;
said aperture is approximately sized to fit a handle of a hand held razor when said aperture is elastically deformed.

15. The system of claim 14, wherein the cap and housing are composed of plastic and the elastomer sleeve is composed of silicone.

16. The system of claim 1, wherein the battery is rechargeable and might be recharged when connected to a DC power source via an integral, waterproof, DC power connector that penetrates the housing.
